(19) United States
(12) Patent Application Publication
(10) Pub. No.: US 2012/0249024 A1
(43) Pub. Date: Oct. 4, 2012

(54) ELECTRIC MOTOR CONTROL DEVICE

(75) Inventors: Subrata SAHA, Anjo (JP); Ken IWATSUKI, Anjo (JP)

(73) Assignee: AISIN AW CO., LTD., ANJO-SHI (JP)

(21) Appl. No.: 13/428,689

(22) Filed: Mar. 23, 2012

(30) Foreign Application Priority Data
Mar. 30, 2011 (JP) 2011-076561

(51) Int. Cl. H02P 21/00

(52) U.S. Cl. 318/400.02

(57) ABSTRACT

An electric motor control device includes a mode in which an inverter is controlled by a current phase of an armature current in a 2-axis orthogonal vector space, a vector being obtained by synthesizing a field and a drive current along two axes defining the vector space; a high-loss control section that, when extra power results from charging a power storage device, varies the field current in accordance with the extra power to increase the armature current while maintaining torque of an AC electric motor; and the high-loss control section varies the field current to one of a field weakening and a field intensifying side of the electric motor, which results in the higher power loss within a range in which the armature current can be output in the vector space and which is determined based on the DC power source voltage and a rotational speed of the electric motor.

### INCORPORATION BY REFERENCE

The disclosure of Japanese Patent Application No. 2011-076561 filed on Mar. 30, 2011 including the specification, drawings and abstract is incorporated herein by reference in its entirety.

### BACKGROUND OF THE INVENTION

The present invention relates to an electric motor control device that controls an electric motor drive device including an inverter that is interposed between a DC power source including a power storage device and an AC electric motor and performs power conversion between DC power of the DC power source and 3-phase AC power.

### DESCRIPTION OF THE RELATED ART

Automobiles that impose a reduced load on the environment compared to those according to the related art are proposed in order to reduce the load on the environment due to consumption of fossil fuel. Examples of such automobiles include electric vehicles driven by an AC electric motor and hybrid vehicles driven by an internal combustion engine and an AC electric motor. In the electric vehicles and the hybrid vehicles, the AC electric motor and a battery that supplies electric power to the AC electric motor are connected to each other. The AC electric motor not only functions as an electric motor that serves as a drive source for the vehicle, but also functions as an electric generator that generates electric power using kinetic energy of the vehicle or the internal combustion engine. The electric power generated by the AC electric motor is regenerated and stored in the battery. The amount of electric power that can be stored in the battery and the amount of electric power that can be charged in the battery per unit time are prescribed. Thus, when the battery is fully charged or nearly fully charged, or when a large amount of electric power is generated during a short time, the electric power generated by the AC electric motor may not be regenerated to result in extra power. Secondary batteries forming the battery include nickel-hydrogen (NiMH) batteries and lithium (Li)-ion batteries. Both the two types of secondary batteries tend to be degraded when overcharge or overdischarge occurs. In particular, the lithium-ion batteries, which have high power storage efficiency and thus are expected to increase the capacity of automotive batteries, are affected by overcharge or overdischarge more easily than the nickel-hydrogen batteries.

With a view to treating such extra power, Japanese Patent Application Publication No. 2003-134602 (sixth paragraph etc.) describes consuming extra energy by causing a current with a magnitude determined in accordance with the amount of energy that may not be regenerated to flow through an AC electric motor for power generation to cause heat loss. A control method called vector control is known as a method for controlling an AC electric motor. In the vector control, coil currents that flow through stator coils of the AC electric motor for three phases (a multiplicity of phases) are subjected to coordinate conversion to be converted into vector components for a d-axis current (field current), which is in the direction of a magnetic field produced by a permanent magnet disposed in a rotator (the direction of a rotating field), and a q-axis current (drive current), which is in the direction advanced by an electric angle of π/2 with respect to the d-axis, to perform feedback control. In Japanese Patent Application Publication No. 2003-134602, a d-axis current with a magnitude determined in accordance with the amount of regenerated energy is caused to flow through the AC electric motor for power generation to cause heat loss.

### SUMMARY OF THE INVENTION

However, Japanese Patent Application Publication No. 2003-134602 does not at all describe how to determine the value of the d-axis current with a magnitude determined in accordance with the amount of energy to be regenerated. Therefore, the value of the d-axis current that may produce necessary power loss may not be determined appropriately, and necessary power loss may not be produced promptly.

Thus, there is desired an electric motor control device capable of consuming extra power resulting from charge power for charging a power storage device by appropriately setting the value of a field current and promptly producing necessary power loss.

An electric motor control device according to an aspect of the present invention controls an electric motor drive device including an inverter that is interposed between a DC power source including a power storage device and an AC electric motor and performs power conversion between DC power of the DC power source and 3-phase AC power. In the electric motor control device, a control mode in which the inverter is controlled by controlling a current phase of an armature current in a 2-axis orthogonal vector space is defined as a current phase control mode, the armature current being a vector obtained by synthesizing a field current and a drive current along two axes defining the orthogonal vector space. The electric motor control device includes a high-loss control section that, on condition that extra power results from charge power for charging the power storage device in the current phase control mode, varies the field current in accordance with the extra power so as to increase the armature current while maintaining torque of the AC electric motor. The high-loss control section varies the field current to one of a field weakening side, on which a field of the AC electric motor is to be weakened, and a field intensifying side, on which the field of the AC electric motor is to be intensified, that results in the higher power loss within a range in which the armature current can be output in the orthogonal vector space and which is determined on the basis of a DC voltage of the DC power source and a rotational speed of the AC electric motor.

According to the configuration, in the case where extra power results from charge power for charging the power storage device, the field current is varied in accordance with the extra power so as to increase the armature current while maintaining torque of the AC electric motor. Thus, the extra power that may not be charged in the power storage device can be appropriately consumed by the AC electric motor while suppressing fluctuations in output torque of the AC electric motor. This makes it possible to suppress overcharge of the power storage device. In this event, in addition, the high-loss control section varies the field current to one of the field weakening side and the field intensifying side that results in the higher power loss within the range in which the armature current can be output. Thus, it is possible to appropriately set the value of the field current within the range in which the armature current can be output and which is determined on the basis of the DC voltage and the rotational speed of the AC electric motor at that time point, and to promptly produce necessary power loss. Thus, the extra power that may not be charged in the power storage device can be effectively consumed by the AC electric motor.

Here, the high-loss control section may vary the field current, on the basis of a maximum value of power loss for each of the field weakening side and the field intensifying side, to one of the field weakening side and the field intensifying side that results in the larger maximum value, the maximum value being determined in accordance with a magnitude of power loss determined in accordance with an amount of variation in field current for each of the field weakening side and the field intensifying side, and a magnitude of a range over which the field current can be varied for each of the field weakening side and the field intensifying side within the range in which the armature current can be output.

According to the configuration, the field current can be varied to be appropriately selected one of the field weakening side and the field intensifying side that results in the higher power loss within the range in which the armature current can be output and which is determined on the basis of the DC voltage and the rotational speed of the AC electric motor at that time point. Thus, it is possible to promptly produce necessary power loss, and to cause the AC electric motor to effectively consume the extra power that may not be charged in the power storage device.

The high-loss control section may determine which of the field weakening side and the field intensifying side the field current is to be varied to on the basis of a ratio between the DC voltage and the rotational speed of the AC electric motor and a torque command value for the AC electric motor, or on the basis of a modulation rate representing a proportion of an effective value of a voltage command value for the 3-phase AC power to the DC voltage.

According to the configuration, it is possible to determine which of the field weakening side and the field intensifying side the field current is to be varied to by appropriately considering the range over which the field current can be varied for each of the field weakening side and the field intensifying side, the range being determined in accordance with the range in which the armature current can be output, which is determined on the basis of the DC voltage and the rotational speed of the AC electric motor, and the torque command value for the AC electric motor, or in accordance with the modulation rate. Thus, the field current can be varied to be appropriately selected one of the field weakening side and the field intensifying side that results in the higher power loss. This makes it possible to promptly produce necessary power loss, and to cause the AC electric motor to effectively consume the extra power that may not be charged in the power storage device.

The electric motor control device may further include a torque restriction control section that executes torque restriction control, in which output torque of the AC electric motor for power generation is restricted, in accordance with the extra power in the case where a modulation rate representing a proportion of an effective value of a voltage command value for the 3-phase AC power to the DC voltage is equal to or more than a threshold determined in advance.

According to the configuration, output torque of the AC electric motor for power generation can be restricted to suppress occurrence of extra power due to the power generation performed by the AC electric motor in the case where the modulation rate is equal to or more than the threshold determined in advance and therefore it is not appropriate for the high-loss control section to perform control for varying the field current. This makes it possible to suppress overcharge of the power storage device.

The electric motor control device may further include a fundamental current command determination section that determines a fundamental field current command value which is a command value for the field current determined on the basis of a torque command value for the AC electric motor, and the high-loss control section may vary the field current with respect to the fundamental field current command value.

According to the configuration, the high-loss control section varies the field current with respect to the fundamental field current command value, that is, makes the value of the field current different from the fundamental field current command value. Thus, power loss can be increased appropriately compared to normal field control executed with the fundamental field current command value determined on the basis of the torque command value. Suitable examples of the normal field control include maximum torque control and maximum efficiency control.

The electric motor control device may further include a harmonic suppression section that suppresses a high-order harmonic component determined in accordance with the current phase of the armature current in the vector space, the high-order harmonic component being a vibration component to be superimposed on a field current command value and a drive current command value which are command values for the field current and the drive current, respectively, and the harmonic suppression section may generate a harmonic suppression current command value for suppressing the high-order harmonic component to be superimposed on each of the field current command value and the drive current command value on the basis of a magnitude and the current phase of the armature current, and may apply the harmonic suppression current command value to each of the field current command value and the drive current command value.

When the current phase is shifted from an optimum phase, vibration components in the inductance of the armature coils are increased. The vibration components are high-order harmonic components in the current phase. When such harmonic components are produced in the inductance, the harmonic components affect current control and the voltage determined as a result of the current control, and finally affect output torque of the AC electric motor to produce torque ripples. Ripples are also produced in drive power and regenerative power. When high-loss control is executed, in particular, it is highly possible that the armature current is large, and thus it is preferable that the effect of the high-order harmonic components can be suppressed. According to the configuration, the harmonic suppression section generates the harmonic suppression current command value, and applies the harmonic suppression current command value to each of the field current command value and the drive current command value. Thus, the effect of the high-order harmonic components can be effectively suppressed. This makes it possible to stably control the AC electric motor even during the high-loss control. In addition, when the vibration components are suppressed, an instantaneous value of regenerative power is also reduced. Therefore, the possibility that the extra power exceeds the allowable limit of the power storage device is also reduced so that the life of the power storage device is less affected.

### BRIEF DESCRIPTION OF THE DRAWINGS

FIG. 1 is a schematic circuit block diagram showing an exemplary configuration of an electric motor drive device;

FIG. 2 is a schematic block diagram showing an exemplary configuration of an inverter control command determination unit provided in an electric motor control device;

FIG. 3 shows an example of a current command value map;

FIG. 4 is a graph showing an example of increase in power loss due to regulation of a field current;

FIG. 5 shows an example of a field regulation direction determination map;

FIG. 6 is a flowchart showing an example of high-loss control;

FIG. 7 is a schematic block diagram showing an exemplary configuration of a current command determination section;

FIG. 8 shows an example of an integration input regulation section; and

FIG. 9 shows an example of the integration input regulation section.

### DETAILED DESCRIPTION OF THE EMBODIMENTS

An embodiment of the present invention will be described with reference to the drawings using a case where the present invention is applied to a drive device for a hybrid vehicle of a so-called 2-motor split type as an example. The hybrid vehicle includes an internal combustion engine (not shown) and a pair of electric motors (AC electric motors) MG1 and MG2 each serving as a drive power source. The drive device for the hybrid vehicle also includes a differential gear device (not shown) for power distribution that distributes output of the internal combustion engine to the side of a first electric motor MG1 and the side of wheels and a second electric motor MG2. In the embodiment, an electric motor drive device 2 is formed as a device for driving the two electric motors MG1 and MG2. Here, each of the first electric motor MG1 and the second electric motor MG2 is an AC electric motor that operates on 3-phase AC, and an interior permanent magnet synchronous motor (IPMSM). The electric motors MG1 and MG2 operate both as an electric motor and as an electric generator as needed.

The electric motor drive device 2 includes two inverters, namely a first inverter 5A corresponding to the first electric motor MG1 and a second inverter 513 corresponding to the second electric motor MG2. In the embodiment, the electric motor drive device 2 includes a converter 4 that is common to the two inverters 5 (5A and 5B). The converter 4 is a voltage conversion device for converting DC power (voltage) between a system voltage Vdc that is common to the two inverters 5 (5A and 5B) and a stored voltage Vb of a battery 3. The electric motor drive device 2 includes the battery 3, a first smoothing condenser Q1 that smoothes the stored voltage Vb which is the voltage between the positive and negative electrodes of the battery 3, and a second smoothing condenser Q2 that smoothes the system voltage Vdc between the converter 4 and the inverter 5. The battery 3 is configured to supply electric power to the electric motors MG1 and MG2 via the converter 4 and the two inverters 5A and 5B, and to store electric power obtained through power generation performed by the electric motors MG1 and MG2. That is, in the embodiment, the battery 3 functions as the “power storage device” according to the present invention. Examples of the battery 3 include various types of secondary batteries such as nickel-hydrogen secondary batteries and lithium-ion secondary batteries, capacitors, and a combination thereof. The stored voltage Vb which is the voltage between the positive and negative electrodes of the battery 3 is detected by a power source voltage sensor 61 and output to a control device 1. In the embodiment, the battery 3, the first smoothing condenser Q1, the converter 4, and the second smoothing condenser Q2 form a “DC power source 120” according to the present invention. The system voltage Vdc generated by the converter 4 functions as the “DC voltage” of the DC power source 120.

The converter 4 is formed as a DC/DC converter that converts the stored voltage Vb from the battery 3 to generate the desired system voltage Vdc. When the electric motors MG1 and MG2 function as an electric generator, the converter 4 reduces the system voltage Vdc from the inverter 5 and supplies the reduced voltage to the battery 3 to charge the battery 3. The converter 4 includes a reactor LI and voltage conversion switching elements E1 and E2. Here, the converter 4 includes a pair of an upper arm element E1 and a lower arm element E2 connected in series with each other as the voltage conversion switching elements. In the example, insulated gate bipolar transistors (IGBTs) are used as the voltage conversion switching elements E1 and E2.

The emitter of the upper arm element E1 and the collector of the lower arm element E2 are connected to the positive electrode terminal of the battery 3 via the reactor L1. The collector of the upper arm element E1 is connected to a system voltage line 67, to which the voltage boosted by the converter 4 is supplied. The emitter of the lower arm element E2 is connected to a negative electrode line 68, which is connected to the negative electrode terminal of the battery 3. Free-wheel diodes D1 and D2 are connected in parallel with the voltage conversion switching elements E1 and E2, respectively. At least one of the switching elements includes a temperature sensor (not shown) such as a thermistor. Power transistors of various structures such as a bipolar type, a field-effect type, and a MOS type, besides the IGBTs, may be used as the voltage conversion switching elements E1 and E2. This also applies to switching elements E3 to E14 of the inverter 5 to be described below.

The voltage conversion switching elements E1 and E2 operate in accordance with voltage conversion control signals S1 and S2, respectively, output from the control device 1. In the embodiment, the voltage conversion control signals S1 and S2 are a switching control signal for controlling switching of the switching elements E1 and E2, respectively, more specifically a gate drive signal for driving the gate of the switching elements E1 and E2, respectively. This allows the converter 4 to boost the stored voltage Vb supplied from the battery 3 to the desired system voltage Vdc and to supply the system voltage Vdc to the first inverter 5A and the second inverter 5B via the system voltage line 67. The system voltage Vdc generated by the converter 4 is detected by a system voltage sensor 62, and output to the control device 1. In the case where the converter 4 does not boost the stored voltage Vb, the system voltage Vdc is equal to the stored voltage Vb.

The first inverter 5A is a DC/AC conversion device that converts DC power having the system voltage Vdc into AC power to supply the resulting AC power to the first electric motor MG1. The first inverter 5A is formed by a bridge circuit, and includes a plurality of sets of switching elements E3 to E8. Here, the first inverter 5A includes a pair of switching elements for legs of the first electric motor MG1 for respective phases (three phases, namely U-phase, V-phase, and W-phase), which are specifically a U-phase upper arm element E3 and a U-phase lower arm element E4, a V-phase upper arm element E5 and a V-phase lower arm element E6, and a W-phase upper arm element E7 and a W-phase lower arm element E8. In the example, the IGBTs are used as the switching elements E3 to E8. The emitters of the upper arm elements E3, E5, and E7 for the respective phases and the collectors of the lower arm elements E4, E6, and E8 for the respective phases are connected to the coils of the first electric motor MG1 for the respective phases. The collectors of the upper arm elements E3, E5, and E7 for the respective phases are connected to the system voltage line 67. The emitters of the lower arm elements E4, E6, and E8 for the respective phases are connected to the negative electrode line 68. Fly-wheel diodes D3 to D8 are connected in series with the switching elements E3 to E8, respectively. At least one of the two switching elements forming the leg for each phase includes a temperature sensor (not shown) such as a thermistor.

The switching elements E3 to E8 operate in accordance with first inverter control signals S3 to S8, respectively, output from the control device 1. In the embodiment, the first inverter control signals S3 to S8 are a switching control signal for controlling switching of the switching elements E3 to E8, respectively, more specifically a gate drive signal for driving the gate of the switching elements E3 to E8, respectively. This allows the first inverter 5A to convert DC power at the system voltage Vdc into AC power and to supply the resulting AC power to the first electric motor MG1 in order to cause the first electric motor MG1 to output torque determined in accordance with a torque command value TM. In this event, the switching elements E3 to E8 perform a switching operation in accordance with the first inverter control signals S3 to S8 in a control mode such as a pulse width modulation control mode (hereinafter occasionally referred to as “PWM control mode”) CP and a rectangular-wave control mode CS to be discussed later. When the first electric motor MG1 functions as an electric generator, the first inverter 5A converts AC power obtained through power generation into DC power to supply the resulting DC power to the converter 4 via the system voltage line 67.

The second inverter 5B is a DC/AC conversion device that converts DC power having the system voltage Vdc into AC power to supply the resulting AC power to the second electric motor MG2. The second inverter 5B is a bridge circuit having substantially the same configuration as that of the first inverter 5A discussed above, and includes switching elements E9 to E14 to which fly-wheel diodes D9 to D14, respectively, are connected in parallel. At least one of the two switching elements forming the leg for each phase includes a temperature sensor (not shown) such as a thermistor. The emitters of the upper arm elements E9, E11, and E13 for the respective phases and the collectors of the lower arm elements E10, E12, and E14 for the respective phases are connected to the coils of the second electric motor MG2 for the respective phases. The collectors of the upper arm elements E9, E11, and E13 for the respective phases are connected to the system voltage line 67. The emitters of the lower arm elements E10, E12, and E14 for the respective phases are connected to the negative electrode line 68. The switching elements E9 to E14 operate in accordance with second inverter control signals S9 to S14, respectively, output from the control device 1. This allows the second inverter 5B to convert DC power at the system voltage Vdc into AC power and to supply the resulting AC power to the second electric motor MG2 in order to cause the second electric motor MG2 to output torque determined depending on the torque command value TM. In this event, the switching elements E9 to E14 perform a switching operation in accordance with the second inverter control signals S9 to S14 in a control mode such as the PWM control mode CP and the rectangular-wave control mode CS to be discussed later. When the second electric motor MG2 functions as an electric generator, the second inverter 5B converts AC power obtained through power generation into DC power to supply the resulting DC power to the converter 4 via the system voltage line 67.

A first current sensor 63A detects an actual current Ir1 that flows between the first inverter 5A and the coils of the first electric motor MG1 for the respective phases. A second current sensor 63B detects an actual current Ir2 that flows between the second inverter 5B and the coils of the second electric motor MG2 for the respective phases. The detected actual currents are output to the control device 1. Here, the actual currents Ir1 and Ir2 include an actual U-phase current, an actual V-phase current, and an actual W-phase current corresponding to three phases. In the example, the sensors are configured to detect the currents for all the three phases. Because the three phases are balanced and the sum of the instantaneous values of the currents for the three phases is zero, however, the currents for only two phases may be detected by the sensors, and the current for the remaining phase may be computed by the control device 1. A first rotation sensor 65A detects a magnetic pole position θ1 of the rotor of the first electric motor MG1 at each time point. A second rotation sensor 65B detects a magnetic pole position θ2 of the rotor of the second electric motor MG2 at each time point. The detected magnetic pole positions are output to the control device 1. The rotation sensors 65A and 65B are each formed by a resolver or the like, for example. The magnetic pole positions θ1 and θ2 each represent the rotational angle of the rotor in terms of electrical angle. The stators include a temperature sensor (not shown) such as a thermistor. A torque command value TM1 for the first electric motor MG1 and a torque command value TM2 for the second electric motor MG2 are input to the control device 1 as a signal representing a request from another control device or the like such as a vehicle control device (not shown).

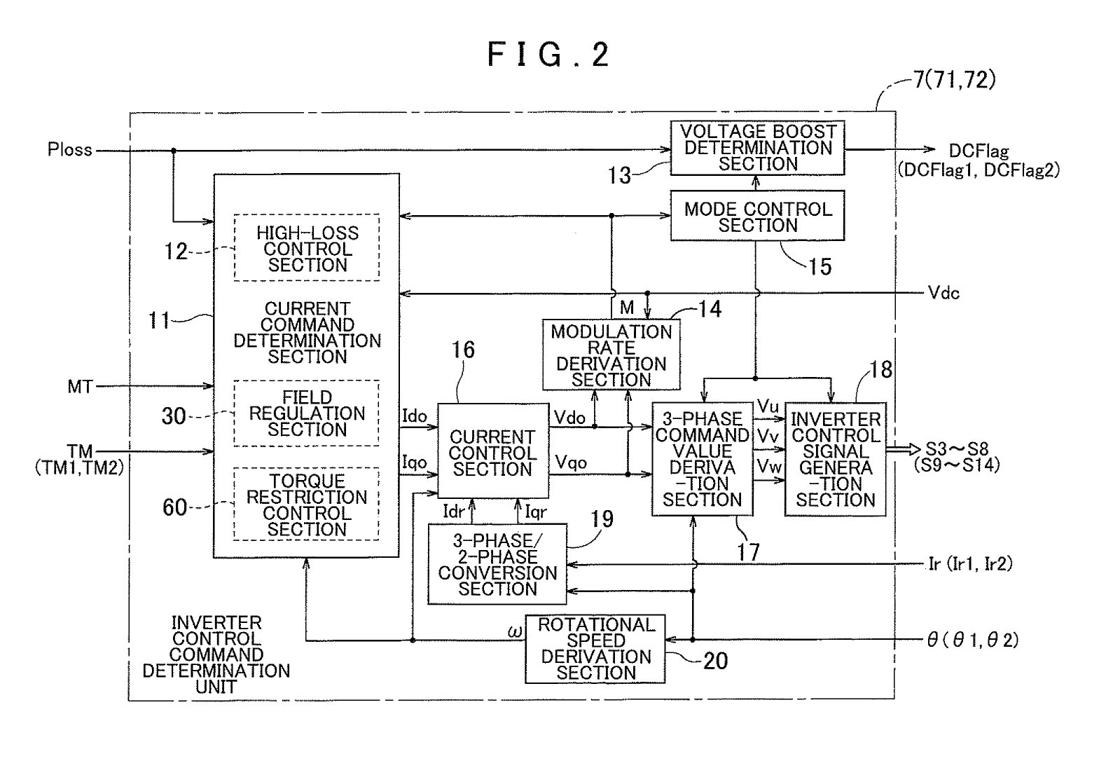

Functional sections of the control device 1 which controls the electric motor drive device 2 are implemented by hardware, software (a program), or a combination of both that performs various processes on input data with a logic circuit such as a microcomputer serving as a core member. In the embodiment, the control device 1 controls the electric motors MG1 and MG2 via the inverters 5A and 5B through current feedback control using a vector control method. The control device 1 also controls the converter 4 to generate the desired system voltage Vdc through DC voltage conversion control. As discussed above, the control device 1 controls the two inverters 5A and 5B corresponding to the two electric motors MG1 and MG2, respectively. Thus, the control device 1 includes two inverter control command determination units 7 (see FIG. 2), namely a first inverter control command determination unit 71 that controls the first inverter 5A and a second inverter control command determination unit 72 that controls the second inverter 5B. The control device 1 also includes a single voltage conversion command determination unit (not shown) that controls the single converter 4.

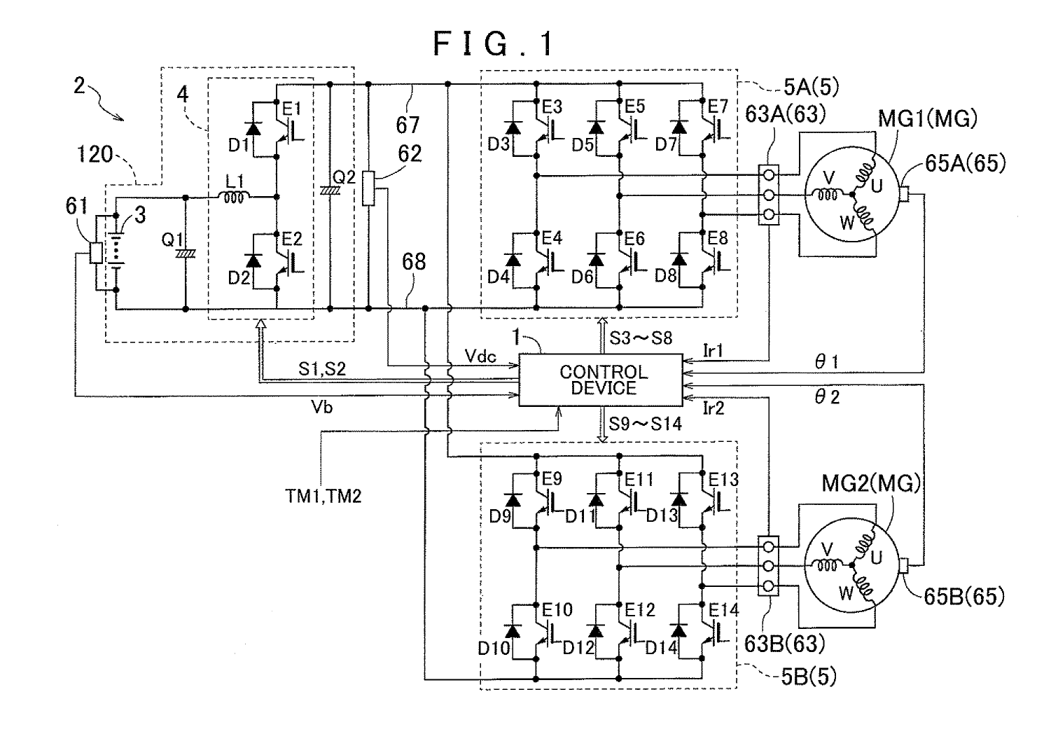

As shown in FIG. 1, the control device 1 performs control in which the voltage conversion control signals S1 and S2 for driving the converter 4 are generated and output to convert the stored voltage Vb in order to generate the desired system voltage Vdc to be supplied to the two inverters 5A and 5B. The control device 1 also performs control in which the first inverter control signals S3 to S8 for driving the first inverter 5A and the second inverter control signals S9 to S14 for driving the second inverter 5B are generated and output to drive the two electric motors MG1 and MG2 via the inverters 5. In this event, the control device 1 selects one of a plurality of control modes to cause the inverters 5 to execute the selected control mode. The control device 1 has at least two control modes, namely PWM control and rectangular-wave control, as the modes of switching patterns (modes of voltage waveform control) for the switching elements E3 to E14 forming the inverter 5. The control device 1 also has at least two control modes, namely normal field control (maximum torque control) and field weakening control, as the modes of field control for the stators. Here, for simplicity to facilitate understanding, it is assumed that the PWM control is performed along with the normal field control, and that the rectangular-wave control is performed along with the field weakening control.

Here, the normal field control is a control mode in which no regulation is performed on fundamental current command values set on the basis of the torque command value TM for the electric motor MG. In the embodiment, maximum torque control is performed as the normal field control. The maximum torque control as used herein refers to so-called maximum torque current control, in which a current phase β of an armature current Ia in a vector space is determined so as to maximize output torque of the electric motor MG for the same armature current Ia. In the maximum torque control, torque can be produced most efficiently for a current flowing through the stator coils of the electric motor MG. Meanwhile, the field weakening control is a control mode in which a d-axis current command value is regulated to weaken the field of the stators by regulating a d-axis current Id (field current) which is a current component along one of axes defining a two-axis vector space. The armature current Ia is a vector obtained by synthesizing the d-axis current Id and a q-axis current Iq (drive current) in the two-axis orthogonal vector space. The current phase β is the angle between the armature current Ia and the q-axis (axis for the drive current), and corresponds to the field angle.

In the PWM control, the duty of each pulse is set such that a PWM waveform, which is the output voltage waveform of the inverter 5 for each of the U-, V-, and W-phases, is formed by a collection of pulses forming a high-level period for which the upper arm elements are turned on and a low-level period for which the lower arm elements are turned on, and such that the fundamental-wave component of the PWM waveform in a certain period forms a generally sinusoidal wave. The PWM control includes sinusoidal PWM (SPWM), space vector PWM (SVPWM), overmodulation PWM control, and so forth known in the art. In general, the PWM control is performed along with the normal field control. In the embodiment, the control mode in which the PWM control is performed along with the normal field control is referred to as “PWM control mode CP”. In the PWM control mode CP, the inverter 5 is driven by controlling the current phase β. Thus, the PWM control mode functions as the “current phase control mode” according to the present invention.

In the rectangular-wave control, the inverter 5 is controlled by controlling the voltage phase of 3-phase AC power. The voltage phase of 3-phase AC power corresponds to the phases of 3-phase voltage command values Vu, Vv, and Vw to be discussed later. In the embodiment, the rectangular-wave control is rotation synchronization control in which each of the switching elements of the inverter 5 is turned on and off once each per one cycle of the electric motors MG in terms of electrical angle and in which one pulse is output for each phase per one cycle in terms of electrical angle. In general, the rectangular-wave control is performed along with the field weakening control. In the embodiment, the control mode in which the rectangular-wave control is performed along with the field weakening control is referred to as “rectangular-wave control mode CS”. In the rectangular-wave control mode CS, the inverter 5 is driven by controlling the voltage phase of 3-phase AC power. Thus, the rectangular-wave control mode functions as the “voltage phase control mode” according to the present invention.

Now, the configuration of the inverter control command determination unit 7 will be described. As described above, the control device 1 includes the two inverter control command determination units 71 and 72 corresponding to the two inverters 5A and 513, respectively. Here, the functions of the first inverter control command determination unit 71 and the second inverter control command determination unit 72 are substantially the same as each other. Therefore, the first inverter control command determination unit 71 and the second inverter control command determination unit 72 are hereinafter simply referred to as “inverter control command determination unit 7” unless it is specifically necessary to distinguish them from each other. In addition, the first electric motor MG1 and the second electric motor MG2 are also simply referred to as “electric motor MG” unless it is specifically necessary to distinguish them from each other. The inverters 5A and 5B are also simply referred to as “inverter 5”. This also applied to the current sensor 63 (63A and 6313) and the rotation sensor 65 (65A and 65B). The values input to and output from the inverter control command determination units 71 and 72 are denoted by the following common reference symbols:

Magnetic pole position θ of the electric motor MG: θ1 and θ2

Actual current Ir flowing through the electric motor MG: Ir1 and Ir2

Torque command value for the electric motor MG: TM1 and TM2

Rotational speed ω of the electric motor MG: ω1 and ω2

Voltage boost request signal DCFlag: DCFlag1 and DCFlag2

As discussed above, the inverter control command determination unit 7 performs current feedback control using a current vector control method. In the current vector control method, the current feedback control is performed in the two-axis orthogonal vector space defined by a d-axis in the direction of magnetic flux of the rotating field and a q-axis in the direction advanced by an electric angle of π/2 with respect to the direction of the field. Specifically, d-axis and q-axis current command values are determined on the basis of the torque command value TM for the electric motor MG to be controlled, and the current actually flowing through the electric motor MG is detected to perform feedback control so as to cause the electric motor MG to output torque determined depending on the torque command value TM. Hereinafter, a current along the d-axis is referred to as the d-axis current Id, and a current along the q-axis is referred to as the q-axis current Iq. The d-axis current Id functions as the “field current” according to the present invention, and the q-axis current Iq functions as the “drive current” according to the present invention. In the case where voltages and inductances are dealt in the vector space, the voltages and the inductances are appropriately referred to as d-axis voltage, q-axis voltage, d-axis inductance, q-axis inductance, and so forth.

As shown in FIG. 2, a current command determination section 11 receives as an input the target torque value TM for the electric motor MG to be controlled. The current command determination section 11 determines current command values Ido and Iqo on the basis of the torque command value TM. As discussed later, the current command determination section 11 determines the final current command values Ido and Iqo specifically by regulating the d-axis current. A 3-phase/2-phase conversion section 19 receives as an input the actual current Ir (the actual U-phase current, the actual V-phase current, and the actual W-phase current) detected by the current sensor 63 to convert the received actual current into an actual d-axis current Idr and an actual q-axis current Iqr in the two-axis vector space. The actual d-axis current Idr and the actual q-axis current Iqr are derived on the basis of the actual current Ir detected by the current sensor 63 and the magnetic pole position θ detected by the rotation sensor 65. A rotational speed derivation section 20 derives the rotational speed ω of the electric motor MG on the basis of the magnetic pole position θ detected by the rotation sensor 65. A current control section 16 receives as inputs the current command values Ido and Iqo determined by the current command determination section 11, the actual currents Idr and Iqr obtained through the conversion performed by the 3-phase/2-phase conversion section 19, and the rotational speed ω of the electric motor MG to be controlled from the rotational speed derivation section 20.

The current control section 16 derives a d-axis current deviation δId, which is the deviation between the d-axis current command value Ido and the actual d-axis current Idr, and a q-axis current deviation δIq, which is the deviation between the q-axis current command value Iqo and the actual q-axis current Iqr. The current control section 16 then performs proportional-integral control computation (PI control computation) on the basis of the d-axis current deviation δId to derive a fundamental d-axis voltage command value Vdi, and performs proportional-integral control computation on the basis of the q-axis current deviation δIq to derive a fundamental q-axis voltage command value Vqi. It is also suitable to perform proportional-integral-differential control computation (PID control computation) in place of the proportional-integral control computation.

The current control section 16 derives a d-axis voltage command value Vdo by subtracting a q-axis armature reaction Eq from the fundamental d-axis voltage command value Vdi as indicated by the following formula (1):

Vdo=Vdi−Eq=Vdi−ω·Lq·Iqr (1)

As indicated by the formula (1), the q-axis armature reaction Eq is derived on the basis of the rotational speed ω of the electric motor MG, the actual q-axis current Iqr, and a q-axis inductance Lq.

The current control section 16 further derives a q-axis voltage command value Vqo by adding a d-axis armature reaction Ed and an induced voltage Em due to armature flux linkage of the permanent magnet to the fundamental q-axis voltage command value Vqi as indicated by the following formula (2):

Vqo=Vqi+Ed+Em=Vqi+ω·Ld·Idr+ω·Φ (2)

As indicated by the formula (2), the d-axis armature reaction Ed is derived on the basis of the rotational speed ω of the electric motor MG, the actual d-axis current Idr, and a d-axis inductance Ld. In addition, the induced voltage Em is derived on the basis of an induced voltage constant Φ, which is determined in accordance with the effective value of the armature flux linkage of the permanent magnet, and the rotational speed co of the electric motor MG.

A 3-phase command value derivation section 17 receives as inputs the d-axis voltage command value Vdo and the q-axis voltage command value Vqo. The 3-phase command value derivation section 17 also receives as an input the magnetic pole position θ detected by the rotation sensor 65. The 3-phase command value derivation section 17 performs 2-phase/3-phase conversion on the d-axis voltage command value Vdo and the q-axis voltage command value Vqo using the magnetic pole position θ to derive AC voltage command values for three phases, namely a U-phase voltage command value Vu, a V-phase voltage command value Vv, and a W-phase voltage command value Vw. The waveforms of the AC voltage command values Vu, Vv, and Vw are different among the control modes. Thus, the 3-phase command value derivation section 17 outputs the AC voltage command values Vu, Vv, and Vw, the voltage waveforms of which are different among the control modes, to an inverter control signal generation section 18.

Specifically, in the case where a command for execution of the PWM control is received from a mode control section 15, the 3-phase command value derivation section 17 outputs the AC voltage command values Vu, Vv, and Vw with AC voltage waveforms corresponding to the PWM control. For example, the 3-phase command value derivation section 17 outputs the AC voltage command values Vu, Vv, and Vw corresponding to the sinusoidal PWM (SPWM), the space vector PWM (SVPWM), and so forth. In the case where a command for execution of the rectangular-wave control is received from the mode control section 15, meanwhile, the 3-phase command value derivation section 17 outputs the AC voltage command values Vu, Vv, and Vw with AC voltage waveforms corresponding to the rectangular-wave control. Here, the AC voltage command values Vu, Vv, and Vw during execution of the rectangular-wave control may be command values for phases at which the switching elements E3 to E8 (E9 to E14) of the inverter 5 are turned on and off. The command values correspond to on/off control signals for the switching elements E3 to E8 (E9 to E14), and represent the phase of the magnetic pole position θ representing the timing to switch on and off the switching elements E3 to E8 (E9 to E14).

The inverter control signal generation section 18 generates the inverter control signals S3 to S8 (S9 to S14) for controlling the switching elements E3 to E8 (E9 to E14), respectively, of the inverter 5 in accordance with the 3-phase voltage command values Vu, Vv, and Vw. Then, the inverter 5 turns on and off the switching elements E3 to E8 (E9 to E14) in accordance with the inverter control signals S3 to S8 (S9 to 514), respectively. This allows the PWM control or the rectangular-wave control to be performed on the electric motor MG.

Here, the mode control section 15 is a functional section that determines the control mode by selecting one of the PWM control mode CP and the rectangular-wave control mode CS on the basis of a modulation rate. Here, the modulation rate M is an index representing the proportion of the 3-phase AC power to the system voltage Vdc as a DC voltage. Specifically, the modulation rate M is the proportion of the effective value of the inter-phase voltage for the 3-phase voltage command values Vu, Vv, and Vw to the system voltage Vdc. The effective value of the inter-phase voltage for the 3-phase voltage command values Vu, Vv, and Vw can be represented by a vector Va obtained by synthesizing the voltage command values Vdo and Vqo in the orthogonal vector space. Thus, the modulation rate M can be calculated as indicated by the following formula (3):

M=(((Vdo)²+(Vqo)²)^{1/2})/Vdc=Va/Vdc (3)

The modulation rate M is derived by a modulation rate derivation section 14. The mode control section 15 selects the PWM control mode CP when the modulation rate M is less than a predetermined mode control threshold, and selects the rectangular-wave control mode CS when the modulation rate M is not less than the mode control threshold. In the embodiment, the mode control threshold is set to “0.78”, which is the theoretically possible maximum value of the modulation rate M, for example.

Here, for example, it is assumed that the first electric motor MG1 is functioning as an electric motor, and that the second electric motor MG2 is functioning as an electric generator. It is also assumed that the battery 3 has been sufficiently charged to a substantially fully charged state. Here, if the amount of electric power generated by the second electric motor MG2 exceeds the amount of electric power consumed by the first electric motor MG1, extra power that may not be regenerated to be stored in the battery 3 is produced. In addition, in the case where the rotational speed ω2 of the second electric motor MG2 is abruptly raised during regeneration with the wheels slipping, in the case where torque regenerated by the second electric motor MG2 for suppressing slip of the wheels is abruptly increased, or the like with the second electric motor MG2 drivably coupled to the wheels, for example, a large amount of electric power is generated during a short time, and therefore electric power may not be regenerated to be stored in the battery 3 to result in extra power. Such extra power may lead to overcharge of the battery 3 to affect the life of the battery 3. Thus, the extra power is consumed as a loss in the electric motor drive device 2 to suppress overcharge and protect the battery 3.

One of methods for increasing loss in the electric motor drive device 2 is to increase a modulation frequency mf for the PWM control (the switching frequency for the inverter 5) (modulation frequency switching control). Increasing the number of switchings per unit time increases switching loss in the inverter 5 (power loss due to opening and closing of the switching elements). Another method is to increase loss in the stators (power loss due to iron loss and copper loss) by increasing the armature current Ia that flows through the stator coils (high-loss field current control). Specifically, loss is produced by increasing the armature current Ia by varying the d-axis current (field current) of the electric motor MG in accordance with the extra power. The modulation frequency switching control and the high-loss field current control are collectively referred to as high-loss control (high-loss control in the broad sense). The high-loss field current control is occasionally simply referred to as high-loss control (high-loss control in the narrow sense). In the embodiment, the high-loss field current control is executed by a high-loss control section 12 of the current command determination section 11. The modulation frequency switching control is executed by a modulation frequency control section (not shown) of the control device 1 by controlling the modulation frequency mf for the inverter control signal generation section 18. For example, the modulation frequency control section controls the modulation frequency mf on the basis of a loss command value floss to be discussed later.

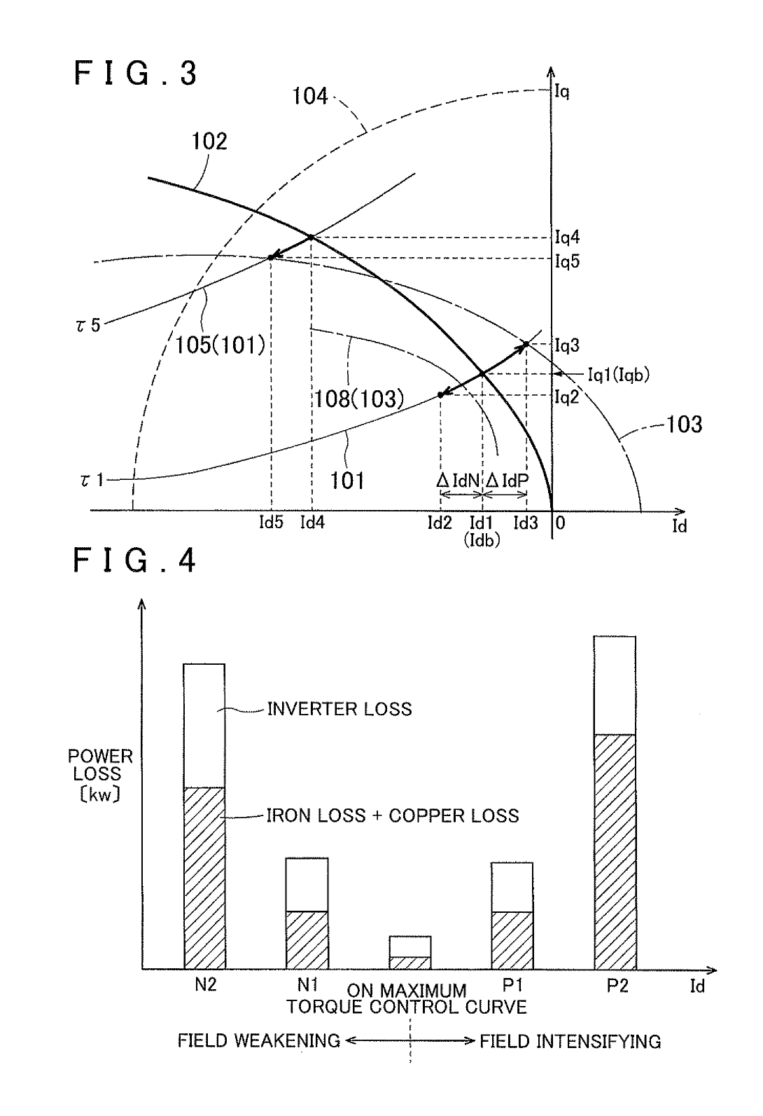

A specific example in which the d-axis current (field current) is varied is described with reference to FIG. 3 which shows an example of a current command value map. A curve 101 is an equal torque curve indicating a vector locus for the armature current Ia on which the electric motor MG outputs constant torque τ1. A curve 102 is a maximum torque control curve indicating a vector locus for the armature current Ia at the current phase β on which the electric motor MG outputs maximum torque for the same armature current Ia. The torque τ1 can be output most efficiently with the d-axis current Id and the q-axis current Iq having values at the intersection between the equal torque curve 101 and the maximum torque control curve 102. That is, when the maximum torque control is executed as the normal field control, the values of the d-axis current Id and the q-axis current Iq at the intersection between the equal torque curve 101 and the maximum torque control curve 102 are determined as the current command values Ido and Iqo. Thus, in the embodiment, the values of the d-axis current Id and the q-axis current Iq at the intersection between the equal torque curve 101 and the maximum torque control curve 102 are used as a fundamental d-axis current command value Idi (fundamental field current command value) and a fundamental q-axis current command value Iqi (fundamental drive current command value).

A curve 103 is a voltage restriction ellipse (voltage/speed ellipse), the size of which is determined on the basis of the system voltage Vdc and the rotational speed ω of the electric motor MG. Specifically, the diameter of the voltage restriction ellipse 103 is proportional to the system voltage Vdc, and inversely proportional to the rotational speed ω. In other words, the diameter of the voltage restriction ellipse 103 is proportional to a voltage/speed ratio Vdc/ω which is the ratio of the system voltage Vdc to the rotational speed ω. A curve 104 indicates a current restriction circle (maximum current circle), the size of which is determined on the basis of the maximum value of a current that can be constantly applied to the electric motor MG, that is, the rated current. Thus, the diameter of the current restriction circle 104 has a constant value determined in accordance with the configuration of the electric motor MG, the characteristics required for the electric motor MG, and so forth. It is necessary that the values of the d-axis current Id and the q-axis current Iq should be selected from a point inside the voltage restriction ellipse 103 and the current restriction circle 104. In the case where the voltage restriction ellipse 103 is in the state shown in FIG. 3 and the torque command value TM for the electric motor MG is τ1, the intersection between the equal torque curve 101 and the maximum torque control curve 102 is (Id1, Iq1). Because the point (Id1, Iq1) is located inside the voltage restriction ellipse 103 and the current restriction circle 104, the PWM control mode CP in which the PWM control is performed along with the normal field control (maximum efficiency control) is selected in the case where the torque command value. TM for the electric motor MG is τ1. In the PWM control mode CP, the d-axis current command value Ido (=Id1) and the q-axis current command value Iqo (=Iq1) coincide with the fundamental d-axis current command value Idi and the fundamental q-axis current command value Iqi, respectively.

In the case where the torque command value TM for the electric motor MG is τ5, meanwhile, the intersection (Id4, Iq4) between the maximum torque control curve 102 and an equal torque curve 105 is located outside the voltage restriction ellipse 103. Thus, the values of the d-axis current Id and the q-axis current Iq at the intersection (Id4, Iq4) cannot be set as the current command values Ido and Iqo. In this case, it is necessary to perform field weakening control in which the d-axis current Id is varied in the negative direction at least until the intersection (Id5, Iq5) between the equal torque curve 105 and the voltage restriction ellipse 103 is reached. Thus, in the case where the voltage restriction ellipse 103 is in the state shown in FIG. 3 and the torque command value TM for the electric motor MG is τ5, the rectangular-wave control mode CS in which the rectangular-wave control is executed along with the field weakening control is selected.

In the case where the torque command value TM for the electric motor MG is τ1, as shown in FIG. 3, varying the d-axis current Id by ΔIdN in the negative direction, that is, leftward in the drawing, on the equal torque curve 101 from the intersection (fundamental current command values Idb and Iqb) between the equal torque curve 101 and the maximum torque control curve 102 weakens the field. Conversely, varying the d-axis current Id by ΔIdP in the positive direction, that is, rightward in the drawing, on the equal torque curve 101 from the intersection between the equal torque curve 101 and the maximum torque control curve 102 intensifies the field. That is, Id and Iq are moved to Id2 and Iq2, respectively, in the case where a field weakening current ΔIdN is added to the fundamental d-axis current command value Idi, and Id and Iq are moved to Id3 and Iq3, respectively, in the case where a field intensifying current ΔIdP is added to the fundamental d-axis current command value Idi. By varying the d-axis current Id by adding the field weakening current ΔIdN or the field intensifying current ΔIdP to the fundamental d-axis current command value Idi in this way, the vector for the armature current Ia deviates from the maximum torque control curve 102. Thus, the armature current Ia can be increased to increase power loss. In this event, the d-axis current Id is varied on the equal torque curve 101. Thus, output torque of the electric motor MG is maintained. The high-loss control section 12 executes the high-loss control by varying the d-axis current Id in this way.

In the case where the torque command value TM for the electric motor MG is τ5, meanwhile, the rectangular-wave control has already been performed along with the field weakening control by adding a field weakening current. Therefore, the high-loss control is not performed simply. Thus, in the embodiment, the high-loss control section 12 performs the high-loss control after transition into the normal field control made by boosting the system voltage Vdc to increase the diameter of the voltage restriction ellipse 103 determined on the basis of the system voltage Vdc and the rotational speed ω of the electric motor MG.

That is, in the case where the control mode is the PWM control mode CP in which the PWM control is performed along with the normal field control, the inverter 5 is driven by controlling the current phase β of the armature current in the orthogonal vector space, and thus can vary the d-axis current Id. In the case where the control mode is the rectangular-wave control mode CS in which the rectangular-wave control is performed along with the field weakening control, meanwhile, the inverter 5 is driven by controlling the voltage phase of 3-phase AC power, and thus cannot control the current phase β of the armature current Ia. That is, the inverter 5 cannot vary the d-axis current Id. Thus, when the high-loss control is to be performed with the inverter 5 driven in the rectangular-wave control mode CS, it is necessary to change the control mode from the rectangular-wave control mode CS to the PWM control mode CP.

As described above, the mode control section 15 selects the control mode on the basis of the modulation rate M and the mode control threshold (in the example, 0.78, which is theoretically possible maximum value of the modulation rate M). The rectangular-wave control mode CS is selected when the modulation rate M is not less than the mode control threshold. Thus, in order to change the control mode to the PWM control mode CP, it is necessary to set the modulation rate M indicated by the formula (3) cited again below to a value less than the mode control threshold:

M=(((Vdo)²+(Vqo)²)^{1/2})/Vdc=Va/Vdc (3)

As is clear from the formula (3), in order to reduce the modulation rate M with the output of the electric motor MG maintained, it is necessary to increase the system voltage Vdc with an effective value Va of the voltage maintained. That is, it is necessary that the converter 4 should boost the voltage.

As shown in FIG. 2, a voltage boost determination section 13 determines whether or not to execute a voltage boost on the basis of the loss command value Ploss indicating the amount of extra power that needs to be consumed and the current system voltage Vdc. Specifically, in the case where the loss command value Ploss is not zero and the system voltage Vdc is less than a voltage boost upper limit voltage Vdcmax, the voltage boost determination section 13 determines to execute a voltage boost. In the case where it is determined that a voltage boost is required, the voltage boost determination section 13 outputs a voltage boost request signal DCFlag to a voltage conversion command determination unit (not shown). For example, in the case where charge power for charging the battery 3 results in extra power during execution of the rectangular-wave control mode CS, the voltage boost determination section 13 determines to cause the converter 4 to boost the system voltage Vdc in order to reduce the modulation rate M to be less than the mode control threshold on condition that the system voltage Vdc has not reached the voltage boost upper limit voltage Vdcmax. When the system voltage Vdc is boosted so that the modulation rate M becomes less than the mode control threshold, the control mode is changed to the PWM control mode CP to enable the high-loss control section 12 to execute the high-loss control in which the d-axis current Id is varied. The voltage boost upper limit voltage Vdcmax is the upper limit value of the system voltage Vdc that can be generated by the converter 4 by boosting the stored voltage Vb, and set in advance in accordance with the characteristics of the electric motor MG, the inverter 5, etc.

The high-loss control section 12 executes the high-loss control in which the d-axis current Id is varied in accordance with the extra power so as to increase the armature current Ia while maintaining torque of the electric motor MG on condition that charge power for charging the battery 3 results in extra power in the PWM control mode CP (current phase control mode) in which the PWM control is performed along with the normal field control. In this event, the high-loss control section 12 varies the d-axis current Id as the field current to one of a field weakening side, on which the field of the electric motor MG is to be weakened, and a field intensifying side, on which the field of the electric motor MG is to be intensified, that results in the higher power loss within a range in which the armature current Ia can be output in the orthogonal vector space (d-q-axis vector space). The range in which the armature current Ia can be output is determined on the basis of the voltage restriction ellipse 103 which is varied in accordance with the system voltage Vdc and the rotational speed ω of the electric motor MG, as described later. In the embodiment, the high-loss control section 12 varies the d-axis current with respect to the fundamental d-axis current command value Idi. In other words, the high-loss control section 12 sets the d-axis current to a value that is different from the fundamental d-axis current command value Idi. In the embodiment, as described above, the maximum torque control is executed as the normal field control, and the values of the d-axis current Id and the q-axis current Iq set on the maximum torque control curve 102 such that desired torque can be output are used as the fundamental d-axis current command value Idi and the fundamental q-axis current command value Iqi. The high-loss control section 12 varies the d-axis current Id from the fundamental d-axis current command value Idi to increase the armature current Ia and to increase loss such as copper loss and switching loss.

As shown in FIG. 3, by adding either of the field weakening current ΔIdN, which is the d-axis current on the field weakening side, and the field intensifying current ΔIdP, which is the d-axis current on the field intensifying side, the values of the d-axis current Id and the q-axis current Iq deviate from the maximum torque control curve 102, and therefore power loss is caused to consume the extra power. FIG. 4 is a graph in which power loss with the electric motor MG for use in the example used under predetermined drive conditions is compared between a case where the d-axis current Id and the q-axis current Iq are set on the maximum torque control curve 102 and a case where the field weakening current ΔIdN or the field intensifying current ΔIdP is added. As shown in the example of FIG. 4, power loss is significantly increased in the case where either of the field weakening current ΔIdN and the field intensifying current ΔIdP is added compared to the case where the d-axis current Id and the q-axis current Iq are set on the maximum torque control curve 102. Thus, either of the field weakening current ΔIdN and the field intensifying current ΔIdP may be added during the high-loss control. However, one of the field weakening current ΔIdN and the field intensifying current ΔIdP that results in the higher power loss is preferably selected because necessary power loss is produced more promptly. It should be noted, however, that it is necessary that the d-axis current Id and the q-axis current Iq should be set inside the voltage restriction ellipse 103 and the current restriction circle 104, which define the range in which the armature current Ia can be output in the orthogonal vector space.

Thus, the high-loss control section 12 varies the d-axis current Id, on the basis of the maximum value of power loss for each of the field weakening side and the field intensifying side, to one of the field weakening side and the field intensifying side that results in the larger maximum value, the maximum value being determined in accordance with the magnitude of power loss determined depending on the amount of variation in d-axis current Id for each of the field weakening side and the field intensifying side, and in accordance with the magnitude of the range over which the d-axis current Id can be varied for each of the field weakening side and the field intensifying side within the range in which the armature current Ia can be output. The magnitude of power loss determined depending on the amount of variation in d-axis current Id for each of the field weakening side and the field intensifying side is determined in accordance with the specific characteristics of the electric motor MG and the drive conditions such as the torque command value TM. In the example shown in FIG. 4, the magnitude of power loss determined depending on the amount of variation in d-axis current Id for the field intensifying side tends to be larger than the magnitude of power loss determined depending on the amount of variation in d-axis current Id for the field weakening side. This is considered to be because varying the d-axis current Id to the field intensifying side with respect to the fundamental d-axis current command value Idi apparently intensifies field magnetic flux to increase iron loss. The relationship between the amount of variation in d-axis current Id with respect to the fundamental d-axis current command value Idi and power loss for each of the field weakening side and the field intensifying side may be prescribed as a map for drive conditions of each electric motor MG or a function approximating such a relationship through experimental measurement performed in advance while varying the drive conditions for each electric motor MG. Here, the drive conditions of the electric motor MG include the torque command value TM, the rotational speed ω, the system voltage Vdc, the switching frequency of the inverter 5, and so forth.

As shown in FIG. 3, the range in which the armature current Ia can be output is prescribed by the voltage restriction ellipse 103 and the current restriction circle 104. As described above, the diameter of the voltage restriction ellipse 103 is proportional to the voltage/speed ratio Vdc/ω. Meanwhile, the diameter of the current restriction circle 104 has a constant value determined in accordance with the configuration of the electric motor MG etc. Thus, the magnitude of the range over which the d-axis current Id can be varied within the range in which the armature current Ia can be output becomes larger on the field intensifying side in the case where the diameter of the voltage restriction ellipse 103 is sufficiently large, and becomes larger on the field weakening side as the diameter of the voltage restriction ellipse 103 becomes smaller. Also during the high-loss control, the values of the d-axis current Id and the q-axis current Iq are determined on the equal torque curve 101 determined depending on the torque command value TM. As is clear from FIG. 3, the equal torque curve 101 is positioned more and more in the upper part of the drawing as the torque command value TM becomes larger. Therefore, the range of the d-axis current Id that can be set inside the voltage restriction ellipse 103 and the current restriction circle 104 becomes narrower as the torque command value TM becomes larger. From what has been described above, the magnitude of the range over which the d-axis current Id can be varied for each of the field weakening side and the field intensifying side within the range in which the armature current Ia can be output is determined in accordance with the system voltage Vdc as a DC voltage, the rotational speed co of the electric motor MG, and the torque command value TM for the electric motor MG. Thus, the relationship between the magnitude of the range over which the d-axis current Id can be varied for each of the field weakening side and the field intensifying side and the system voltage Vdc, the rotational speed ω, and the torque command value TM can be prescribed as a map or a function approximating such a relationship.

Then, the high-loss control section 12 varies the d-axis current Id, in accordance with the magnitude of power loss determined depending on the amount of variation in d-axis current Id for each of the field weakening side and the field intensifying side and the magnitude of the range over which the d-axis current Id can be varied for each of the field weakening side and the field intensifying side determined as described above, to one of the field weakening side and the field intensifying side that results in the larger maximum value of power loss. That is, the high-loss control section 12 varies the d-axis current Id to one of the field weakening side and the field intensifying side corresponding to the larger of the maximum value of power loss produced in the case where the d-axis current Id is varied within the range over which the d-axis current Id can be varied on the field weakening side and the maximum value of power loss produced in the case where the d-axis current Id is varied within the range over which the d-axis current Id can be varied on the field intensifying side. Which of the maximum value of power loss for the field weakening side and the maximum value of power loss for the field intensifying side is the larger can be determined through computation using a map or a relational formula representing the relationship between the amount of variation in d-axis current Id with respect to the fundamental d-axis current command value Idi and power loss for each of the field weakening side and the field intensifying side discussed above, and using a map or a relational formula representing the relationship between the magnitude of the range over which the d-axis current Id can be varied for each of the field weakening side and the field intensifying side and the system voltage Vdc, the rotational speed ω, and the torque command value TM. It should be noted, however, that a d-axis current regulation direction determination map 110 in which the results of such computation are prescribed in advance is used in the embodiment in order to alleviate the load of the computation.

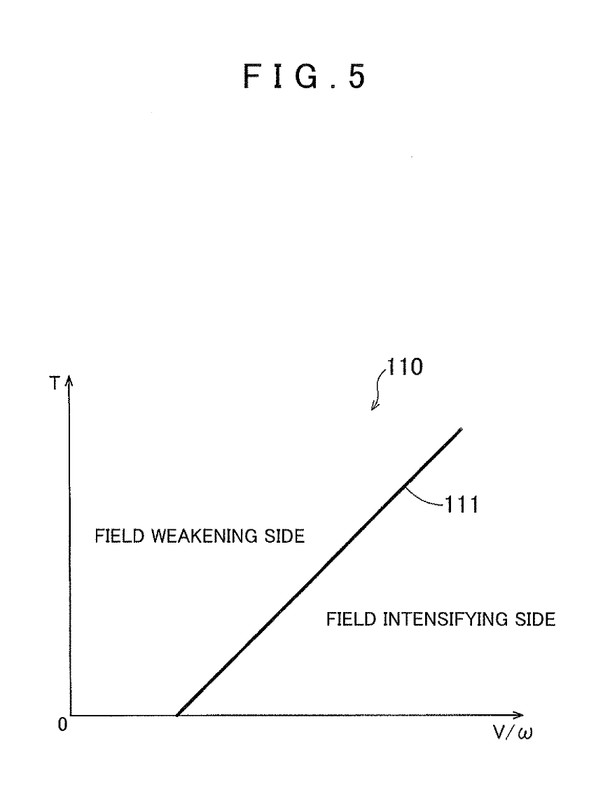

FIG. 5 shows an example of the d-axis current regulation direction determination map 110. The d-axis current regulation direction determination map 110 is a map defining which of the field weakening side and the field intensifying side the d-axis current Id is to be varied to in accordance with the relationship between the voltage/speed ratio Vdc/ω and the torque command value TM for the electric motor MG A boundary line 111 between the field weakening side and the field intensifying side in the map 110 corresponds to a line representing the relationship between the voltage/speed ratio Vdc/ω and the torque command value TM on which the maximum value of power loss produced in the case where the d-axis current Id is varied within the range over which the d-axis current Id can be varied on the field weakening side and the maximum value of power loss produced in the case where the d-axis current Id is varied within the range over which the d-axis current Id can be varied on the field intensifying side are the same as each other. The high-loss control section 12 determines which of the field weakening side and the field intensifying side the d-axis current Id is to be varied to on the basis of the voltage/speed ratio Vdc/ω and the torque command value TM using the map 110. As shown in FIG. 2, the current command determination section 11 including the high-loss control section 12 receives as inputs the system voltage Vdc as a DC voltage, the rotational speed ω of the electric motor MG, the torque command value TM for the electric motor MG, the modulation rate M, and so forth. Thus, the high-loss control section 12 can determine which direction the d-axis current Id is to be varied in on the basis of such information.

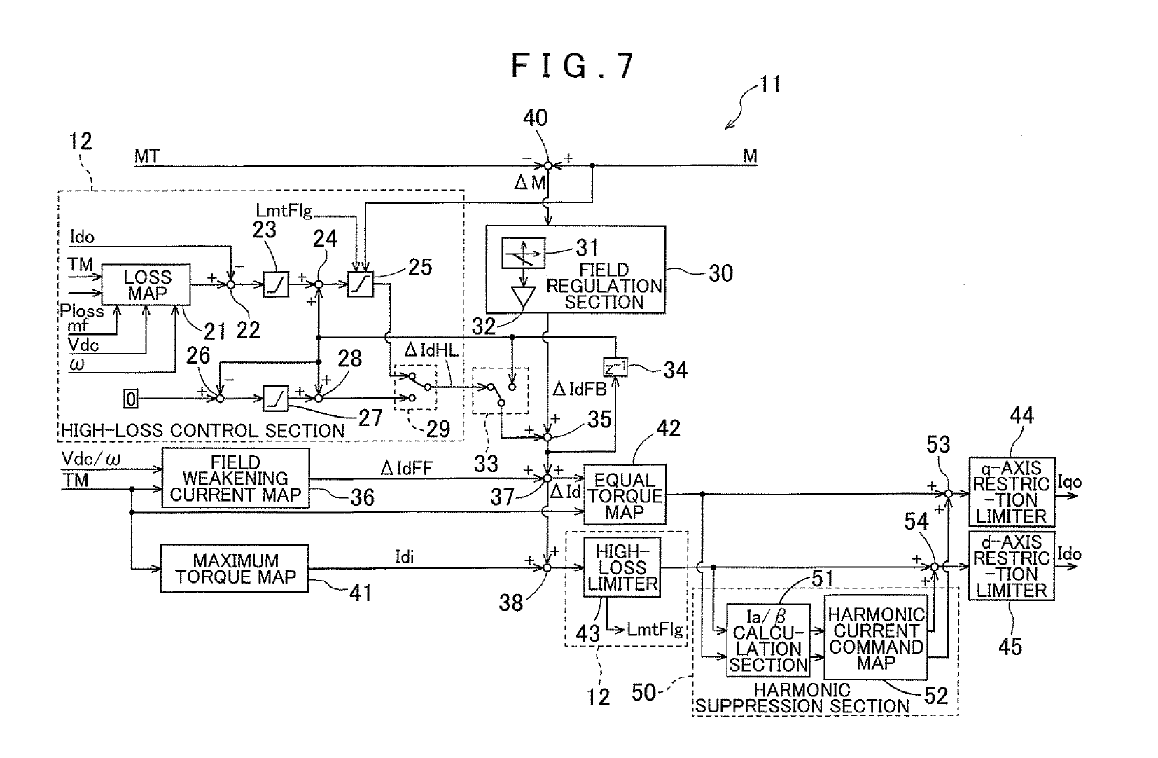

The current command determination section 11 also includes a torque restriction control section 60. In the embodiment, in the case where the system voltage Vdc has reached the voltage boost upper limit voltage Vdcmax and the modulation rate M is equal to or more than a threshold determined in advance, the torque restriction control section 60 executes torque restriction control in which output torque of the electric motor MG for power generation is restricted in accordance with the extra power. That is, in the embodiment, in the case where it is necessary to execute the high-loss control during execution of the rectangular-wave control mode CS, the voltage boost determination section 13 boosts the system voltage Vdc until the system voltage Vdc reaches the voltage boost upper limit voltage Vdcmax so that the control mode is changed to the PWM control mode CP, and then the high-loss control section 12 performs the high-loss control as described above. Then, in the case where the modulation rate M is equal to or more than the mode control threshold and the rectangular-wave control mode CS is executed even when the system voltage Vdc has reached the voltage boost upper limit voltage Vdcmax, the torque restriction control is executed by the torque restriction control section 60. As described above, during execution of the rectangular-wave control mode CS, the field weakening control is executed by the field regulation section 30 along with the rectangular-wave control. As described later with reference to FIG. 7, when the field weakening control is started, the d-axis current Id is regulated in accordance with the field weakening control, and the high-loss control is suspended. Thus, the torque restriction control section 60 restricts output torque of the electric motor MG for power generation to suppress electric power generated by the electric motor MG and hence occurrence of extra power due to the power generation.

During execution of the torque restriction control, the torque restriction control section 60 determines torque to be restricted in accordance with the magnitude of the extra power. That is, the torque restriction control section 60 determines restriction torque ΔTM, which is torque by which the torque command value TM is decreased, so as to decrease the amount of electric power generated by the electric motor MG by an amount corresponding to the extra power. Specifically, the restriction torque ΔTM can be calculated as a value obtained by dividing the loss command value Ploss (see FIG. 2), which indicates the magnitude of the extra power, by the rotational speed ω of the electric motor MG as indicated by the following formula (4):

ΔTM=Ploss/ω (4)

Through such torque restriction control, occurrence of the extra power due to the power generation performed by the electric motor MG can be suppressed to suppress overcharge of the battery 3.

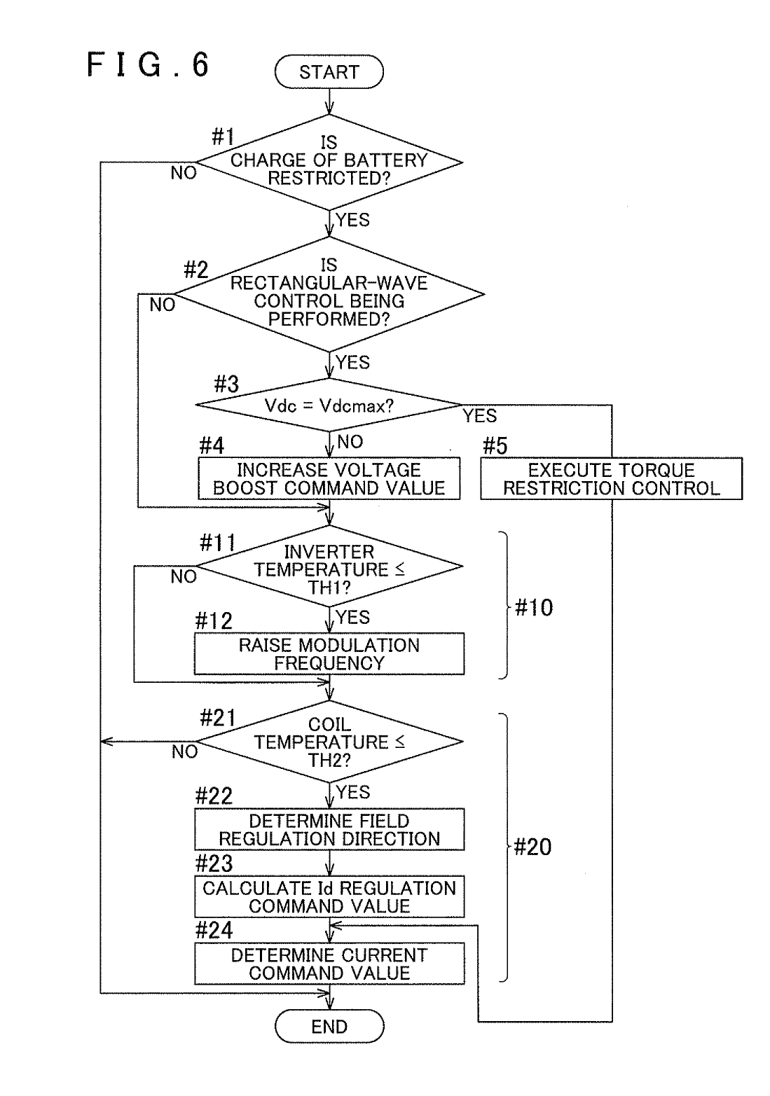

Next, the flow of the high-loss control (in the broad sense) and the torque restriction control will be described with reference to the flowchart of FIG. 6. First, it is determined whether or not charge of the battery 3 is restricted (#1). For example, the current command determination section 11 or the voltage boost determination section 13 determines on the basis of the loss command value Ploss that charge of the battery 3 is restricted if the loss command value Ploss is not zero (see FIGS. 2 and 7). Also, the modulation frequency control section (not shown) determines on the basis of the loss command value Ploss that charge of the battery 3 is restricted if the loss command value Ploss is not zero. In the case where charge is not restricted (step #1: No), the process is terminated, In the case where charge is restricted (step #1: Yes), on the other hand, it is next determined whether or not control is being performed in the rectangular-wave control mode CS (#2). In the case where control is being performed in the rectangular-wave control mode CS (step #2: Yes), it is determined whether or not the system voltage Vdc has reached the voltage boost upper limit voltage Vdcmax (step #3). In the case where the system voltage Vdc is not equal to or more than the voltage boost upper limit voltage Vdcmax (step #3: No), a voltage boost command value is increased (#4) in order for the converter 4 to boost the voltage. In the case where the system voltage Vdc has reached the voltage boost upper limit voltage Vdcmax (step #3: Yes), the torque restriction control is executed by the torque restriction control section 60 (step #5).

For example, the voltage boost determination section 13 determines that charge is restricted and that control is being performed in the rectangular-wave control mode CS on the basis of the loss command value Ploss and the control mode. In the case where charge is restricted and control is being performed in the rectangular-wave control mode CS, it is next determined whether or not the converter 4 can further boost the voltage in accordance with whether or not the system voltage Vdc has reached the voltage boost upper limit voltage Vdcmax. If the system voltage Vdc has not reached the voltage boost upper limit voltage Vdcmax, the voltage boost determination section 13 outputs the voltage boost request signal DCFlag to the voltage conversion command determination unit. Then, upon receiving the voltage boost request signal DCFlag, the voltage conversion command determination unit increases the voltage boost command value (#4). At this time, the voltage boost command value may be increased slightly because it is sufficient to at least transition from the rectangular-wave control mode CS to the PWM control mode CP. However, the voltage conversion command determination unit may increase the voltage boost command value to the maximum value since it is currently desirable to increase loss.

In the case where the control mode is the PWM control mode CP (step #02: No), or in the case where transition is made into the PWM control mode CP as a result of the voltage boost (step #4), the modulation frequency switching control (#10) is executed subsequently. In this control, first, it is determined on the basis of the results of detection performed by the temperature sensor provided in the switching element of the inverter 5 whether or not the temperature of the inverter 5 is equal to or less than an inverter temperature threshold TH1 (#11). The inverter temperature threshold TH1 is set to a temperature that is lower than the allowable temperature of the inverter 5. In the case where it is determined that the temperature of the inverter 5 is equal to or less than the inverter temperature threshold TH1 (step #11: Yes), the modulation frequency mf in the inverter control signal generation section 18 is raised by the modulation frequency control section (not shown) (#12). This increases switching loss. In the case where it is determined that the temperature of the inverter 5 is not equal to or less than the inverter temperature threshold TH1 (step #11: No), the modulation frequency switching control (#10) is terminated without changing the modulation frequency fm since it is not preferable that the temperature of the inverter 5 should be raised any further.

Subsequent to the modulation frequency switching control (#10), the high-loss field current control (#20) is executed by the high-loss control section 12. First, it is determined on the basis of the results of detection performed by the temperature sensor provided in the stator whether or not the coil temperature of the stator coil is equal to or less than a coil temperature threshold TH2 (#21). The coil temperature threshold TH2 is set to a temperature that is lower than the allowable temperature of the stator coil. In the case where it is determined that the coil temperature of the stator coil is not equal to or less than the coil temperature threshold TH2 (step #21: No), the high-loss control (#20) is terminated since it is not preferable to increase the armature current Ia in order to increase the amount of generated heat. In the case where the coil temperature is equal to or less than the coil temperature threshold TH2 (step #21: Yes), the field regulation direction is determined (#22). That is, the field regulation direction is determined in order to vary the d-axis current Id (field current) to one of the field weakening side and the field intensifying side that results in the higher power loss within the range in which the armature current Ia can be output as described above. Next, a regulation command value for the d-axis current Id in the determined field regulation direction is calculated (#23). Then, the regulation command value determined depending on the loss command value Ploss indicating the magnitude of the extra power is added to the fundamental current command values Idi and Iqi set on the basis of the torque command value TM to determine the current command values Ido and Iqo (#24).

The configuration of the current command determination section 11 including the high-loss control section 12 will be described with reference to FIG. 7. As discussed above, the current command determination section 11 receives as an input the target torque value TM for the electric motor MG to be controlled. The current command determination section 11 references a maximum torque map 41 defining the relationship between the torque command value TM and the d-axis current Id during execution of the maximum torque control as the normal field control to set the fundamental d-axis current command value Idi for causing the electric motor MG to output torque determined depending on the torque command value TM. A map similar to the current command value map shown in FIG. 3, for example, may be used as the maximum torque map 41. The fundamental d-axis current command value Idi is a d-axis current command value that does not include a regulation amount for the field weakening control, the high-loss control (high-loss field current control), and so forth. Thus, the maximum torque map 41 functions as the “fundamental current command determination section” according to the present invention. A d-axis current regulation value ΔId is added to the fundamental d-axis current command value Idi by an adder 38. An excessive d-axis current command value contained in the d-axis current command value after the addition is suppressed by a high-loss limiter 43. A harmonic suppression current command value generated by a harmonic suppression section 50 is superimposed on the resulting d-axis current command value. Thereafter, the d-axis current command value is applied to a d-axis restriction limiter 45 to be suppressed such that no excessive current command value is added, thereby determining the final d-axis current command value Ido.

The fundamental q-axis current command value Iqi can also be determined using the maximum torque map 41 which is similar to the current command value map shown in FIG. 3. It should be noted, however, that in the embodiment, only the fundamental d-axis current command value Idi is determined using the maximum torque map 41 and the q-axis current command value is determined using an equal torque map 42 after the d-axis current regulation value ΔId, which is a regulation amount for the fundamental d-axis current command value Idi, is determined. Specifically, the q-axis current command value Iqo is determined as follows. First, a field weakening current map 36 is referenced using the torque command value TM, the system voltage Vdc, and the rotational speed ω as arguments to set a feedforward regulation value ΔIdFF for the field weakening current. Next, a feedback regulation value ΔIdFB for the field weakening current and a high-loss regulation value ΔIdHL are added to the feedforward regulation value ΔIdFF by an adder 37 to calculate the d-axis current regulation value ΔId. As discussed in detail later, one of the feedback regulation value ΔIdFB and the high-loss regulation value ΔIdHL is selectively used. Next, a q-axis current command value is determined using the equal torque map 42 on the basis of the torque command value TM and the d-axis current regulation value ΔId. A map similar to the current command value map shown in FIG. 3, for example, may be used as the equal torque map 42. Then, as with the d-axis, a harmonic suppression current command value generated by the harmonic suppression section 50 is superimposed on the resulting q-axis current command value. Thereafter, the q-axis current command value is applied to a q-axis restriction limiter 44 to be suppressed such that no excessive current command value is added, thereby determining the final q-axis current command value Iqo.

The harmonic suppression section 50 includes an Ia/β calculation section 51 that calculates the armature current Ia and the current phase β on the basis of the d-axis and q-axis current command values Ido and Iqo before superimposition of the harmonic suppression current command value, and a harmonic current command map 52 for setting the harmonic suppression current command value on the basis of the armature current Ia and the current phase β. If the amount of the armature current Ia is large, or if the current phase β is shifted from an optimum phase in the maximum torque control, high-order harmonic components, such as 6th-order and 12th-order harmonic components, tend to be increased. As a result, current control may be performed in a vibrating manner, which also increases harmonic vibration components in torque and electric power. Vibration in electric power may cause vibration in regenerative power for the battery 3. In the scene where extra power is produced, the instantaneous value of the extra power may exceed the allowable range because of the vibration.

The harmonic suppression section 50 generates the harmonic suppression current command value on the basis of the magnitude and the current phase β of the armature current Ia. The harmonic suppression current command value has a waveform that is opposite in phase to the high-order harmonic components, such as 6th-order and 12th-order harmonic components, and is generated for each of Id and Iq. High-order harmonic components are suppressed with a signal in the opposite phase superimposed on each of the d-axis current command value Ido (field current command value) and the q-axis current command value Iqo (drive current command value). As shown in FIG. 7, the harmonic suppression current command value is applied to each of the d-axis current command value Ido and the q-axis current command value Iqo by adders 53 and 54, respectively.

Of the feedback regulation value ΔIdFB and the high-loss regulation value ΔIdHL, one of which is selectively used, the high-loss regulation value ΔIdHL is determined by the high-loss control section 12. The high-loss control section 12 will be described below. A loss map 21 is used to set a high-loss d-axis current command value using the torque command value TM, the loss command value Ploss, the modulation frequency mf, the system voltage Vdc, and the rotational speed ω as arguments. The loss map 21 includes features for determining which of the field weakening side and the field intensifying side the d-axis current Id is to be varied to as discussed above. Therefore, the loss map 21 includes the content of the d-axis current regulation direction determination map 110 shown in FIG. 5, for example. Then, the high-loss d-axis current command value, which is obtained by varying the d-axis current Id to the field weakening side or the field intensifying side with respect to the fundamental d-axis current command value Idi in accordance with the loss command value Ploss representing extra power etc., is determined on the basis of the loss map 21. The high-loss d-axis current command value is a command value for the d-axis current for consuming the extra power. An adder (subtractor) 22 subtracts the d-axis current command value Ido from the high-loss d-axis current command value to calculate a fundamental high-loss regulation value. That is, the difference between the d-axis current command value for producing loss in the stator coils and the current d-axis current command value Ido (computed in the preceding computation cycle) is used as the initial regulation value. A rate limiter 23 restricts the calculated fundamental high-loss regulation value to a predetermined restriction value. That is, a large regulation value abruptly varies the d-axis current command value Ido. Thus, the fundamental high-loss regulation value is restricted by the rate limiter 23 to suppress such abrupt variations.

Next, the current high-loss regulation value (ΔIdHL) (computed in the preceding computation cycle) and the latest fundamental high-loss regulation value are added by an adder 24. The current d-axis regulation value (ΔIdHL) (computed in the preceding computation cycle) is included in the current d-axis current command value Ido (computed in the preceding computation cycle), but it has been subtracted by the adder 22. Since the d-axis current regulation value ΔId is added to the fundamental d-axis current command value Idi by the adder 38 as discussed above, it is necessary to add the high-loss regulation value ΔIdHL included in the current d-axis current regulation value ΔId (computed in the preceding computation cycle). Thus, output of a Z converter 34 that feeds back the high-loss regulation value ΔIdHL computed in the preceding computation cycle and the latest fundamental high-loss regulation value are added by the adder 24.

A limiter 25 restricts an increase in high-loss regulation value ΔIdHL by fixing the high-loss regulation value ΔIdHL at the current value when a high-loss limit flag LmtFlg is activated and when the modulation rate M is equal to or more than the mode control threshold. The high-loss limit flag LmtFlg is activated when the d-axis current command value is restricted by the high-loss limiter 43. The restriction value of the high-loss limiter 43 is set to a value that is smaller than that of the d-axis restriction limiter 45 in a later stage. For example, the restriction value has a current value that is lower by about 50 A. When the modulation rate M is equal to or more than the mode control threshold, the field weakening control is automatically executed by the field regulation section 30. When the field weakening control is started, the d-axis current is regulated through the field weakening control, and thus the high-loss control is suspended.

If the rotational speed ω is raised after the system voltage Vdc reaches the voltage boost upper limit voltage Vdcmax during execution of the high-loss control, the diameter of the voltage restriction ellipse 103 becomes smaller. Then, when the size of a voltage restriction ellipse indicated by reference numeral 108 in FIG. 3 is reached, for example, the field weakening control is required. In such a case, the modulation rate M also becomes equal to or more than the mode control threshold, and the mode control section 15 executes the rectangular-wave control mode CS. When execution of the rectangular-wave control mode CS is started, the field weakening control is automatically executed by the field regulation section 30, the d-axis current is regulated through the field weakening control, and thus the high-loss control is suspended. In this case, the torque restriction control is executed by the torque restriction control section 60 as discussed above.

A switch 29 selects output of the limiter 25 for output during execution of the high-loss control. That is, the switch 29 outputs the latest high-loss regulation value ΔIdHL if no restrictions are imposed by the rate limiter 23 and the limiter 25. A switch 33 selects the high-loss regulation value ΔIdHL for output during execution of the high-loss control, and selects the feedback regulation value ΔIdFB for output during execution of the field weakening control. An adder 35 adds the feedback regulation value ΔIdFB and the high-loss regulation value ΔIdHL to output the resulting sum to the adder 37. During execution of the high-loss control, the switch 33 selects the high-loss regulation value ΔIdHL, and the field weakening control is not executed. Thus, the adder 35 outputs the high-loss regulation value ΔIdHL during execution of the high-loss control. Thus, the adder 37 adds the feedforward regulation value ΔIdFF and the high-loss regulation value ΔIdHL to calculate the d-axis current regulation value ΔId.

In the case where there is no more extra power or the field weakening control is started, a high-loss control flag is inactivated. The switch 29 switches to select output of an adder 28 on the basis of the high-loss control flag. An adder (subtractor) 26 subtracts output of the Z converter 34 from zero. A rate limiter 27 restricts output of the adder 26 to a predetermined restriction value. That is, if output of the adder 26 is large (the high-loss regulation value ΔIdHL so far is large), input of the switch 29 is varied abruptly. Thus, the amount of the variation is restricted to suppress such abrupt variations. Output of the rate limiter 27 and output of the Z converter 34 are added by the adder 28. That is, since output of the rate limiter 27 is negative, the high-loss regulation value ΔIdHL decreases within the range of restriction defined by the rate limiter 27.

In the case where there is no more extra power and the high-loss control flag is inactivated, the switch 33 selects the high-loss regulation value ΔIdHL at least unless the high-loss regulation value ΔIdHL is zero. Thus, the high-loss regulation value ΔIdHL decreases stepwise to become zero through the switch 33, the adder 35, the Z converter 34, the adder 26, the rate limiter 27, the adder 28, and the switch 29. This makes it possible to suppress abrupt variations in d-axis current command value Ido when the high-loss control is terminated. In the case where the field weakening control is started, the switch 33 switches to select the feedback regulation value ΔIdFB. Since the high-loss regulation value ΔIdHL for at least one computation cycle is fed back via the Z converter 34, switching from the high-loss control to the field weakening control can be made smoothly.

The feedback regulation value ΔIdFB for the field weakening control is calculated by the field regulation section 30. An adder (subtractor) 40 subtracts a target modulation rate MT from the modulation rate M to derive a modulation rate deviation ΔM as indicated by the following formula (5) to output the derived modulation rate deviation ΔM to the field regulation section 30.

ΔM=M−MT (5)

In the embodiment, the modulation rate deviation ΔM represents the degree to which the voltage command values Vdo and Vqo exceed the maximum value of AC voltage that can be output in accordance with the system voltage Vdc at that time. Thus, the modulation rate deviation ΔM substantially functions as a voltage insufficiency index representing the degree to which the system voltage Vdc is insufficient. In the example, the target modulation rate MT is set to 0.78, which is the theoretically possible maximum value.

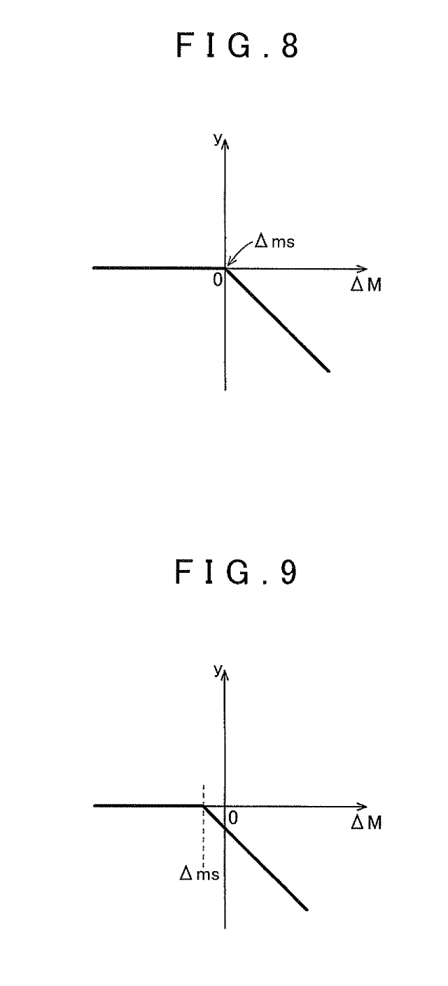

The field regulation section 30 includes an integration input regulation section 31 and an integrator 32. The integration input regulation section 31 receives as an input the modulation rate deviation ΔM. The integration input regulation section 31 imposes predetermined regulation on the value of the modulation rate deviation ΔM to output a regulation value Y, which is the value after the regulation, to the integrator 32. The integration input regulation section 31 outputs zero (y=0) as the regulation value Y with the modulation rate deviation ΔM less than a field weakening start threshold (field control threshold) Δms (=0) as shown in FIG. 8, for example, and outputs a negative regulation value y (y<0) with the modulation rate deviation ΔM not less than the field weakening start threshold Δms (=0). As shown in FIG. 8, the relationship between the modulation rate deviation ΔM and the regulation value y can be represented by a linear function. By setting an area in which the regulation value Y decreases as the modulation rate deviation ΔM increases in a conversion map, control for increasing the absolute value of the feedback regulation value ΔIdFB and increasing the amount of the field weakening current for execution of the field weakening control as the modulation rate M increases can be performed appropriately. The integrator 32 receives as an input the regulation value y derived by the integration input regulation section 31. The integrator 32 integrates the regulation value y using a predetermined gain to derive the resulting integrated value as the feedback regulation value ΔIdFB.

### Other Embodiments

(1) In the embodiment described above, the present invention is applied to a drive device for a hybrid vehicle of a so-called 2-motor split type. That is, the hybrid vehicle includes an electric motor that mainly functions as a drive power source, and an electric motor (electric generator) that mainly functions as a regenerative power source. However, the present invention is not limited thereto. The present invention may also be applied to a drive device for a hybrid vehicle of a so-called 1-motor parallel type, or a drive device for an electric vehicle (electrically driven vehicle). In this case, the drive device includes only a single electric motor MG; and the electric motor drive device 2 includes a single inverter 5 corresponding to the single electric motor MG. In addition, the control device 1 includes a single inverter control command determination unit 7 corresponding to the single inverter 5. The high-loss control section 12 of the inverter control command determination unit 7 executes the high-loss control under particular conditions in the same manner as described above.

(2) In the embodiment described above, the mode control threshold is set to 0.78, which is the theoretically possible maximum value of the modulation rate M. In addition, since the rectangular-wave control is performed along with the field weakening control in the rectangular-wave control mode CS, the field weakening start threshold (field control threshold) Δms is set to zero. This allows the field weakening control to be started when the modulation rate M is equal to or more than 0.78, which is the maximum value of the target modulation rate MT. Thus, when the modulation rate M reaches 0.78, the rectangular-wave control mode CS in which the rectangular-wave control is performed along with the field weakening control is performed. However, the present invention is not limited thereto. The rectangular-wave control mode CS may be performed when the modulation rate M is less than 0.78.

In this case, the field weakening start threshold Δms is preferably set to be less than 0 as shown in FIG. 9 in the integration input regulation section 31, for example. That is, by setting the field weakening start threshold (field control threshold) Δms to a negative value, the field weakening control can be started by outputting the feedback regulation value ΔIdFB before the modulation rate M reaches the target modulation rate MT. For example, by setting the field weakening start threshold Δms to “−0.02”, the field weakening control can be started with the modulation rate M=0.76. This allows the field weakening control to be executed along with the PWM control. If the mode control threshold is decreased by 0.02 to be set to 0.76, along with the decrease in field weakening start threshold Δms, the rectangular-wave control mode CS in which the rectangular-wave control is performed along with the field weakening control can be executed when the modulation rate M becomes 0.76.

(3) In the embodiment described above, the mode control threshold is set to 0.78, which is the theoretically possible maximum value of the modulation rate M, and the torque restriction control section 60 executes the torque restriction control in the case where the modulation rate M is equal to or more than the mode control threshold. However, the present invention is not limited thereto. In one preferred embodiment of the present invention, the threshold for the modulation rate M for starting the torque restriction control may be set to be less than 0.78. For example, in a configuration in which normal PWM control such as sinusoidal PWM or space vector PWM is executed as the PWM control when the modulation rate M is in the range of “0 to 0.707” and overmodulation PWM control is executed as the PWM control when the modulation rate M is “0.707 to 0.78”, it is also preferable to set the threshold for the modulation rate M for starting the torque restriction control to “0.707”, which is the modulation rate at the boundary between the normal PWM control and the overmodulation PWM control. Such a threshold for starting the torque restriction control may also be used as the threshold for terminating the high-loss control performed by the high-loss control section 12. Thus, in this case, the high-loss control section 12 executes the high-loss control on condition that the normal PWM control is executed with the modulation rate M in the range of “0 to 0.707”. Then, the torque restriction control section 60 executes the torque restriction control on condition that the overmodulation PWM control or the rectangular-wave control is executed with the modulation rate M in the range of “0.707 to 0.78”. Such settings of the thresholds are merely illustrative, and the thresholds may be set to other given values.

(4) In the embodiment described above, the electric motor drive device 2 includes the converter 4 for voltage boost. In one preferred embodiment of the present invention, however, the electric motor drive device 2 may be configured to include no converter 4 for voltage boost. Also in this case, the high-loss control section 12 performs the high-loss control on condition that the PWM control mode CP (current phase control mode) is being executed. Meanwhile, the torque restriction control section 60 determines whether or not the modulation rate M is equal to or more than a threshold determined in advance, and executes the torque restriction control in the case where the modulation rate M is equal to or more than the threshold determined in advance. In the flowchart shown in FIG. 6, for example, steps #3 and #4 are not necessary any more, and in the case where it is determined in step #2 that the rectangular-wave control is being performed, the torque restriction control is executed by the torque restriction control section 60, and the process proceeds to step #24. In the case where the electric motor drive device 2 includes no converter 4 for voltage boost, the stored voltage Vb from the battery 3 functions as the “DC voltage” of the DC power source.

(5) In the embodiment described above, the maximum torque control, or so-called maximum torque current control, in which the current phase is determined so as to maximize output torque of the electric motor for the same armature current, is executed as the normal field control. However, the present invention is not limited thereto. Various types of control known in the art may be used as the normal field control. For example, maximum torque magnetic flux control, which is a type of the maximum torque control, may also be used. In the maximum torque magnetic flux control, the field current command value (d-axis current command value) and the drive current command value (q-axis current command value) are determined so as to minimize the armature flux linkage for generating the same torque. Alternatively, the maximum efficiency control may be used as the normal field control. In the maximum efficiency control, the field current command value (d-axis current command value) and the drive current command value (q-axis current command value) are determined so as to minimize loss, that is, maximize the efficiency, under a given load (speed and torque).

(6) In the embodiment described above, the high-loss control section 12 determines which of the field weakening side and the field intensifying side the d-axis current Id is to be varied to on the basis of the ratio between the system voltage Vdc and the rotational speed a of the electric motor MG and the torque command value TM for the electric motor MG. However, the present invention is not limited thereto. The relationship between the ratio between the system voltage Vdc and the rotational speed ω of the electric motor MG and the torque command value TM for the electric motor MG may be substantially replaced with the value of the modulation rate M. Thus, in one preferred embodiment of the present invention, the high-loss control section 12 may be configured to determine which of the field weakening side and the field intensifying side the d-axis current Id is to be varied to on the basis of the modulation rate M. Also in this case, the high-loss control section 12 may be configured to reference a d-axis current regulation direction determination map defining which of the field weakening side and the field intensifying side the d-axis current Id is to be varied to in accordance with the modulation rate M, for example, to determine which direction the d-axis current Id is to be varied in. Alternatively, the high-loss control section 12 may be configured to determine, on the basis of a map or a function defining the relationship between the magnitude of the range over which the d-axis current Id can be varied and the modulation rate M for each of the field weakening side and the field intensifying side, one of the field weakening side and the field intensifying side that results in the larger maximum value of power loss as the direction in which the d-axis current Id is to be varied in the same manner as described above.

The present invention may be applied to an electric motor control device that controls an electric motor drive device including an inverter that is interposed between a DC power source including a power storage device and an AC electric motor and performs power conversion between DC power of the DC power source and 3-phase AC power.

What is claimed is:

1. An electric motor control device that controls an electric motor drive device including an inverter that is interposed between a DC power source including a power storage device and an AC electric motor and performs power conversion between DC power of the DC power source and 3-phase AC power, wherein:
a control mode in which the inverter is controlled by controlling a current phase of an armature current in a 2-axis orthogonal vector space is defined as a current phase control mode, the armature current being a vector obtained by synthesizing a field current and a drive current along two axes defining the orthogonal vector space;
the electric motor control device includes a high-loss control section that, on condition that extra power results from charge power for charging the power storage device in the current phase control mode, varies the field current in accordance with the extra power so as to increase the armature current while maintaining torque of the AC electric motor; and
the high-loss control section varies the field current to one of a field weakening side, on which a field of the AC electric motor is to be weakened, and a field intensifying side, on which the field of the AC electric motor is to be intensified, that results in the higher power loss within a range in which the armature current can be output in the orthogonal vector space and which is determined on the basis of a DC voltage of the DC power source and a rotational speed of the AC electric motor.

2. The electric motor control device according to claim 1, wherein
the high-loss control section varies the field current, on the basis of a maximum value of power loss for each of the field weakening side and the field intensifying side, to one of the field weakening side and the field intensifying side that results in the larger maximum value, the maximum value being determined in accordance with a magnitude of power loss determined depending on an amount of variation in field current for each of the field weakening side and the field intensifying side, and a magnitude of a range over which the field current can be varied for each of the field weakening side and the field intensifying side within the range in which the armature current can be output.

3. The electric motor control device according to claim 1, wherein
the high-loss control section determines which of the field weakening side and the field intensifying side the field current is to be varied to on the basis of a ratio between the DC voltage and the rotational speed of the AC electric motor and a torque command value for the AC electric motor, or on the basis of a modulation rate representing a proportion of an effective value of a voltage command value for the 3-phase AC power to the DC voltage.

4. The electric motor control device according to claim 1, further comprising:
a torque restriction control section that executes torque restriction control, in which output torque of the AC electric motor for power generation is restricted in accordance with the extra power, in the case where a modulation rate representing a proportion of an effective value of a voltage command value for the 3-phase AC power to the DC voltage is equal to or more than a threshold determined in advance.

5. The electric motor control device according to claim 1, further comprising:
a fundamental current command determination section that determines a fundamental field current command value which is a command value for the field current determined on the basis of a torque command value for the AC electric motor, wherein
the high-loss control section varies the field current with respect to the fundamental field current command value.

6. The electric motor control device according to claim 1, further comprising:
a harmonic suppression section that suppresses a high-order harmonic component determined depending on the current phase of the armature current in the vector space, the high-order harmonic component being a vibration component to be superimposed on a field current command value and a drive current command value which are command values for the field current and the drive current, respectively, wherein
the harmonic suppression section generates a harmonic suppression current command value for suppressing the high-order harmonic component to be superimposed on each of the field current command value and the drive current command value on the basis of a magnitude and the current phase of the armature current, and applies the harmonic suppression current command value to each of the field current command value and the drive current command value.
